(19) United States
(12) Patent Application Publication
(10) Pub. No.: US 2025/0118980 A1
(43) Pub. Date: Apr. 10, 2025

(54) V-MOUNT BATTERY AND DISCHARGE CONTROL METHOD

(71) Applicant: Shenzhen Leqi Innovation Co., Ltd., Shenzhen (CN)

(72) Inventor: Wenjie CAO, Shenzhen (CN)

(73) Assignee: Shenzhen Leqi Innovation Co., Ltd., Shenzhen (CN)

(21) Appl. No.: 18/974,647

(22) Filed: Dec. 9, 2024

Related U.S. Application Data
(63) Continuation of application No. PCT/CN2023/114055, filed on Aug. 21, 2023.

(30) Foreign Application Priority Data
Sep. 30, 2022 (CN) 202211212689.5

(51) Int. Cl. H02J 7/00; H01M 10/42

(52) U.S. Cl. CPC H02J 7/0063; H01M 10/425; H02J 7/0029; H02J 7/0047; H02J 7/0068; H02J 7/007; H01M 2010/4271; H02J 2207/20

(57) ABSTRACT

A V-mount battery includes a battery cell; a BMS module electrically connected to the battery cell and configured to monitor electrical parameters of the battery cell and control input and output of the battery cell based on the electrical parameters of the battery cell; an interface module electrically connected to the BMS module and configured to provide an output voltage to an external load based on a discharge voltage of the battery cell when connected to the external load, and to charge the battery cell when connected to an external power source, the interface module comprising a DC output interface; and a voltage transformation module electrically connected to the BMS module and the DC output interface, respectively, the voltage transformation module being configured to convert the discharge voltage of the battery cell to a target output voltage and output the target output voltage to the DC output interface.

### CROSS-REFERENCE TO RELATED APPLICATIONS

The present disclosure is a continuation of International Patent Application No. PCT/CN2023/114055 filed on Aug. 21, 2023, which claims the priority of China Patent Application No. 202211212689.5, filed on Sep. 30, 2022, the entire contents of which are incorporated herein by reference.

### TECHNICAL FIELD

The present disclosure relates to the technical field of mobile power pack, and in particular relates to a V-mount battery and a discharge control method.

### DESCRIPTION OF RELATED ART

V-mount, as a battery standard interface, is mainly used in the mounting interface for camera power supply. With the development of the photography industry and technology, camcorders and cameras require more and more auxiliary devices during use. These auxiliary devices include a variety of electronic auxiliary devices, such as monitors, follow focuses, wireless image transmitters, stabilizers, and so on. The above auxiliary devices may be equipped with various types of power supply interfaces, such as BP electrode interface, USB-A interface, USB-C interface, D-Tap interface, DC interface, etc., so a power supply compatible with the above interfaces is needed. At present, the BP electrode interface and the D-Tap interface have become the basic configuration for V-mount batteries, and some V-mount batteries are also equipped with a USB interface, but they are unable to directly provide an output voltage compatible with the DC interface type, and still need to use an adapter (e.g., V-mount plate) to provide the output voltage of the DC interface type, which makes the existing V-mount batteries inconvenient to use.

### SUMMARY

The present disclosure is directed to a V-mount battery and a discharge control method capable of directly providing an output voltage of a DC interface type.

In one aspect, a V-mount battery includes a battery cell; a BMS module electrically connected to the battery cell and configured to monitor electrical parameters of the battery cell and control input and output of the battery cell based on the electrical parameters of the battery cell; an interface module electrically connected to the BMS module and configured to provide an output voltage to an external load based on a discharge voltage of the battery cell when connected to the external load, and to charge the battery cell when connected to an external power source, the interface module comprising a DC output interface; and a voltage transformation module electrically connected to the BMS module and the DC output interface, respectively, the voltage transformation module being configured to convert the discharge voltage of the battery cell to a target output voltage and output the target output voltage to the DC output interface.

In some embodiments, the V-mount battery further comprises a main control module, the main control module being electrically connected to the interface module, the voltage transformation module, and the BMS module, respectively, the main control module being configured to obtain a load connection status and electrical parameters of each of output interfaces of the interface module, and the electrical parameters of the battery cell, and to control enabling and disabling of part of the output interfaces individually based on the load connection status and electrical parameters of each of the output interfaces of the interface module, and the electrical parameters of the battery cell.

In some embodiments, the interface module comprises a USB-A interface and a USB-C interface, and the V-mount battery comprises a USB interface control module and an Emark module;
wherein the USB interface control module is electrically connected to the BMS module, the Emark module, the USB-A interface, and the USB-C interface, respectively, and the USB interface control module is configured to, when at least one of the USB-C interface and the USB-A interface is connected to the external load, provide the output voltage to the corresponding external load according to the discharge voltage of the battery cell, and charge the battery cell when the USB-C interface is connected to the external power source;
wherein the Emark module is electrically connected to the USB-C interface; and
wherein the main control module is electrically connected to the USB interface control module, the main control module being configured to obtain the load connection status and electrical parameters of each of the USB-A interface and the USB-C interface through the USB interface control module, and to control enabling or disabling of the USB-A interface and USB-C interface individually according to the load connection status and electrical parameters of each of the USB-A interface and the USB-C interface.

In some embodiments, the main control module comprises a voltage stabilizing unit and a main controller unit;
wherein the main controller unit is electrically connected to the BMS module and the USB interface control module, respectively; and
wherein the voltage stabilizing unit is electrically connected to the BMS module and the main controller unit, respectively, and the voltage stabilizing unit is configured to stabilize a voltage supplied from the BMS module to the main controller unit.

In some embodiments, the BMS module comprises a BMS control circuit and a fuse;
wherein one end of the fuse is connected to a positive electrode of the battery cell, and the other end of the fuse is connected to a discharge input end of the BMS control circuit;
wherein a discharge output end of the BMS control circuit is connected to the voltage transformation module, the USB interface control module, and part of the interfaces of the interface module, respectively, and a data transmission end of the BMS control circuit is connected to the main control module.

In some embodiments, the voltage transformation module comprises a switch transistor and a transformer;
wherein an input end of the switch transistor is connected to the discharge output end of the BMS module, an output end of the switch transistor is connected to an input end of the transformer, a control end of the switch transistor is connected to the main control module, and an output end of the transformer is connected to the DC output interface.

In another aspect, a discharge control method is provided for use in a V-mount battery as described above. The interface module includes a BP electrode interface, a D-Tap interface, the DC output interface, a USB-C interface, and a USB-A interface. The discharge control method includes:
obtaining a load connection status of each output interface of the interface module;
obtaining an electrical parameter of each output interface being currently connected with a load;
comparing the electrical parameter of the output interface being currently connected with the load with a corresponding preset threshold range, and outputting a comparison result;
when the electrical parameter of the output interface is not within the preset threshold range, disabling the corresponding output interface; and
when the electrical parameter of the output interface is within the preset threshold range, enabling the corresponding output interface.

In some embodiments, the discharge control method further comprises:
obtaining a current remaining power of the battery;
obtaining a rated power of each remaining output interface currently connected to the load but not supplying power to the load;
comparing the remaining power of the battery with the rated power of each remaining output interface, and controlling the enabling and disabling of the corresponding remaining output interface according to the comparison result.

In some embodiments, the discharge control method further comprises:
obtaining an actual total discharge power of all output interfaces currently supplying power to their loads; and
comparing the actual total discharge power with the rated power of the battery, and controlling turn-on or turn-off of an alarm indication based on a comparison result.

In some embodiments, the discharge control method further comprises:
when the load of any output interface is removed, disabling the output interface corresponding to the load removed;
updating the remaining power of the battery;
comparing the updated remaining power of the battery with the rated power of each remaining output interface currently connected to the load but not supplying power to the load, and controlling the enabling and disabling of the corresponding remaining output interface according to the comparison result;
updating the actual total discharge power;
comparing the updated actual total discharge power with the rated power of the battery again, and controlling turn-on and turn-off of the alarm indication based on the comparison result.

In view of the foregoing, the BMS module controls the input and output of the battery cell, so that when the DC output interface is connected to an external load, the BMS module outputs the discharge voltage of the battery cell to the voltage transformation module, and the voltage transformation module converts the discharge voltage to a target output voltage and then outputs it to the DC output interface, so as to supply power to the external load having a DC power supply interface, thereby avoiding the use of an additional V-mount plate, which is conducive to simplifying the assembly steps. As the DC output interface is disposed on the V-mount battery, the overall volume of the assembled devices such as the camera and the photography light can be reduced, and the integration of the DC output interface with the battery cell reduces external interference, thereby improving the stability of the power supply to the external load.

### BRIEF DESCRIPTION OF THE DRAWINGS

FIG. 1 is a first block diagram showing a circuit of a V-mount battery of an embodiment of the present disclosure.

FIG. 2 is a second block diagram showing a circuit of a V-mount battery of an embodiment of the present disclosure.

FIG. 3 is a third block diagram showing a circuit of a V-mount battery of an embodiment of the present disclosure.

FIG. 4 is a block diagram showing a discharge circuit of a DC output interface of an embodiment of the present disclosure.

FIG. 5 is a fourth block diagram showing a circuit of a V-mount battery of an embodiment.

FIG. 6 is a first flow chart of a discharge control method of an embodiment of the present disclosure.

FIG. 7 is a second flow chart of a discharge control method of an embodiment of the present disclosure.

FIG. 8 is a third flow chart of a discharge control method of an embodiment of the present disclosure.

FIG. 9 is a fourth flow chart of a discharge control method of an embodiment of the present disclosure.

FIG. 10 is a fifth flow chart of a discharge control method of an embodiment of the present disclosure.

FIG. 11 is a workflow chart of a V-mount battery of an embodiment of the present disclosure.

### REFERENCE NUMERALS

100, battery cell; 200, BMS module; 210, fuse; 220, BMS control circuit; 300, interface module; 310, DC output interface; 320, BP electrode interface; 330, D-Tap interface; 340, USB-A interface; 350, USB-C interface; 400, voltage transformation module; 410, switch transistor; 420, transformer; 500, main control module; 510, MCU; 520, voltage stabilizing unit; 600, USB interface control module; 700, Emark module; 800, display module; 920, firmware burning interface; 930, key.

### DESCRIPTION OF THE EMBODIMENTS

The technical solutions, purposes and effects of the present disclosure will be described below in conjunction with the embodiments and the accompanying drawings.

### First Embodiment

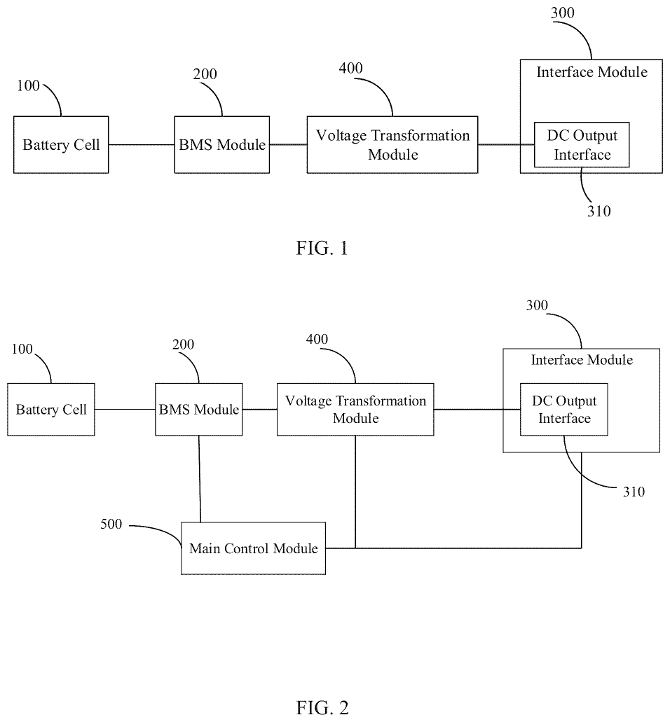

Referring to FIG. 1 through FIG. 5, A V-mount battery in accordance with a first embodiment is applicable to devices such as cameras, photography lights, etc., to supply power to a number of electrical devices.

Referring to FIG. 1, the V-mount battery includes a housing, a battery cell 100, and a circuit board. The battery cell 100 may be implemented as, but not limited to, a single lithium cell or a lithium cell group. The circuit board is provided thereon with a BMS (Battery Management System) module 200, the BMS module 200 is electrically connected to the battery cell 100 for monitoring electrical parameters of the battery cell 100 and controlling an input and output of the battery cell 100 according to the electrical parameters of the battery cell 100. An interface module 300 is electrically connected to the BMS module 200, for providing an output voltage to an external load based on a discharge voltage of the battery cell 100 when connected to the external load, and for charging the battery cell 100 when connected to an external power source. The interface module 300 includes a DC output interface 310. A voltage transformation module 400 is electrically connected to the BMS module 200 and the DC output interface 310, respectively. The voltage transformation module 400 is used to convert the discharge voltage of the battery cell 100 to a target output voltage and output the target output voltage to the DC output interface 310.

The working principle of the V-mount battery of the present embodiment is as follows: the BMS module 200 can be a common protection module for the battery cell 100, specifically using a common BMS control circuit for providing bidirectional protection for the battery cell 100 during the charge and discharge process, such as over-voltage protection, under-voltage protection, over-current protection, short-circuit protection, temperature protection, etc., so as to prevent the service life and performance of the battery cell 100 from being damaged by an abnormality occurring in the charge and discharge process. The BMS module 200 monitors electrical parameters of the power cell 100 and controls the input and output of the power cell 100 according to the electrical parameters of the power cell 100. In the event of an abnormality of the electrical parameters of the battery cell 100, the BMS module 200 disconnects the power cell 100 from the external load or the external power source. The interface module 300 includes a plurality of interfaces with input or output functions. For example, the interface module 300 includes one or more of a BP electrode interface 320, a D-Tap interface 330, a USB interface, a DC output interface 310, and the like, and the number and the size of working voltage of each type of interface may be set according to actual needs. In this embodiment, the interface module 300 includes the DC output interface 310, and when the DC output interface 310 is connected with an external load, in the case of no abnormality, the BMS module 200 controls the battery cell 100 to discharge so as to output the discharge voltage of the battery cell 100 to the voltage transformation module 400. The voltage transformation module 400 boosts or bucks the voltage of the discharge module to obtain a target output voltage with a preset voltage magnitude, and outputs the target output voltage to the DC output interface 310 so as to supply power to the external load through the DC output interface 310.

The electrical parameters mentioned in this embodiment include one or more of current, voltage, power, and the like. The external load includes an auxiliary device such as a monitor, a follow focus, a wireless image transmitter, a stabilizer, and the like.

It can be understood that the present embodiment adopts the above-described configuration to avoid the use of an additional V-mount plate, which is conducive to simplifying the assembly steps. As the DC output interface 310 is disposed on the V-mount battery, the overall volume of an assembled device, e.g., of the camera and the photography light can be reduced, and the integration of the DC output interface 310 with the battery cell 100 reduces external interferences, thereby improving the stability of the power supply to the external load.

Referring to FIG. 2, specifically, the V-mount battery further includes a main control module 500 electrically connected to the interface module 300, the voltage transformation module 400, and the BMS module 200, respectively. The main control module 500 is configured to obtain the load connection status and the electrical parameters of each of the output interfaces of the interface module 300 as well as the electrical parameters of the battery cell 100, and control enabling or disabling of part of the output interfaces individually, based on the load connection status and the electrical parameters of each of the output interfaces of the interface module 300 as well as the electrical parameters of the battery cell 100

It can be understood that the main control module 500 obtains the load connection status and the electrical parameters of each output interface of the interface module 300, and also obtains the electrical parameters of the battery cell 100 through the BMS module 200, and controls the enabling or disabling of part of the output interfaces based on the load connection status of each output interface and a result of computation on the electrical parameters of each output interface and the electrical parameters of the battery cell 100.

For example, by obtaining the load connection status of the DC output interface 310, the main control module 500 detects that the DC output interface 310 is connected with an external load. Then, the main control module 500 obtains the actual discharge power of the DC output interface 310, and compares the actual discharge power with a preset power threshold. When the actual discharge power of the DC output interface 310 does not exceed the preset power threshold, enabling of the DC output interface 310 is maintained; when the actual discharge power of the DC output interface 310 reaches or exceeds the preset power threshold, the DC output interface 310 is disabled.

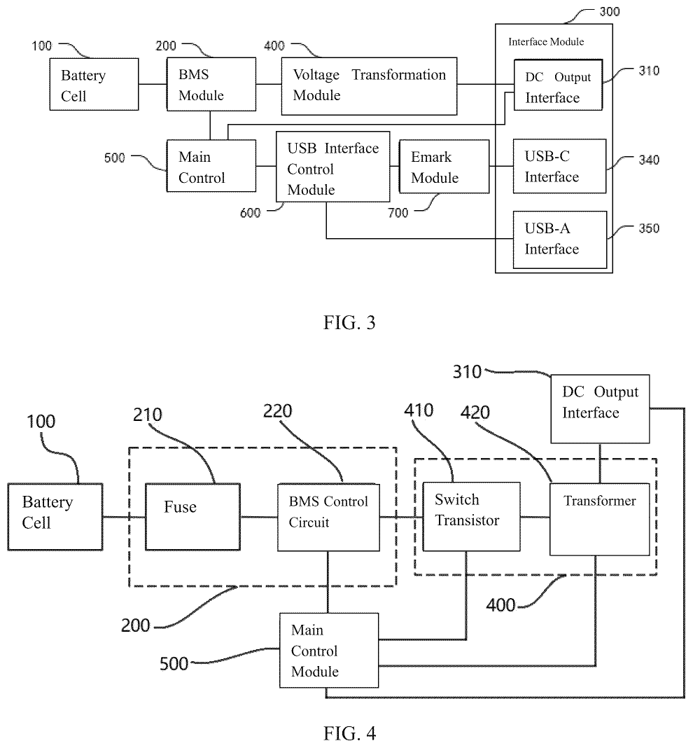

Referring to FIG. 3, optionally, the interface module 300 further includes a USB-A interface 340 and a USB-C interface 350, and the V-mount battery further includes a USB interface control module 600 and an Emark module 700. The USB interface control module 600 is connected to the BMS module 200, the Emark module 700, the USB-A interface 340, and the USB-C interface 350, respectively. The USB interface control module 600 is configured to, when at least one of the USB-C interface 350 and the USB-A interface 340 is connected to an external load, provide an output voltage to the corresponding external load according to the discharge voltage of the battery cell 100, and to charge the battery cell 100 when the USB-C interface 350 is connected to an external power source. The Emark module 700 is electrically connected to the USB-C interface 350, and is configured to recognize whether the external load, the power supply, and the charging cable connected to the USB-C interface 350 can support a power of more than 65 W when the charge and discharge power of the USB-C interface 350 reaches 65 W. The main control module 500 is electrically connected to the USB interface control module 600. The main control module 500 is configured to obtain the load connection status and electrical parameters of the USB-A interface 340 and the USB-C interface 350, respectively, through the USB interface control module 600, and control enabling or disabling of the USB-A interface 340 and the USB-C interface 350 individually and respectively according to the load connection status and electrical parameters of the USB-A interface 340 and the USB-C interface 350.

In this embodiment, the V-mount battery further includes the USB-A interface 340 and USB-C interface 350 to supply power to external loads of corresponding interface types. The USB-C interface 350 is a bidirectional power transmission interface and is connected to the Emark module 700, which can realize the output and input of 65 W power to realize the fast charge of the battery cell 100 and the power supply to external loads with a 65 W power demand. The USB interface control module 600 can adopt an existing USB control chip to monitor the electrical parameters of each USB interface, provide discharge overcurrent protection for each USB interface, and provide charge overvoltage and overcurrent protection during the USB charging process of the battery cell 100. Further, the main control module 500 obtains the load connection status and electrical parameters of each USB interface through the USB interface control module 600, and controls the enabling or disabling of the USB interfaces individually and respectively according to the obtained data.

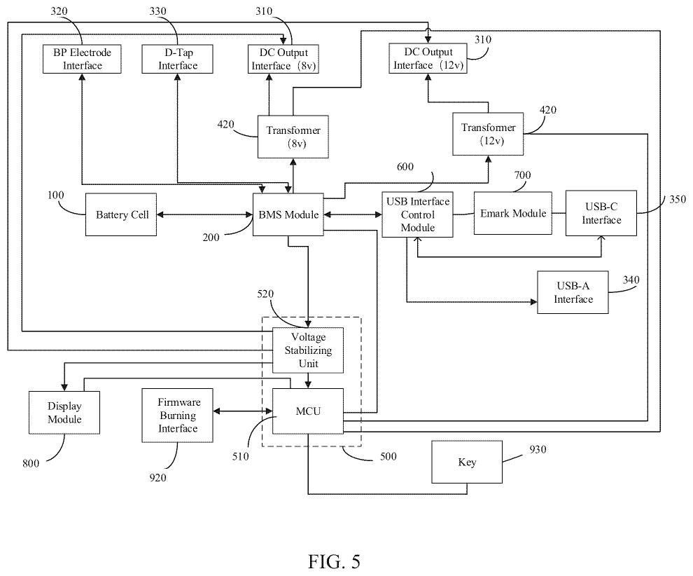

Referring to FIG. 5, optionally, the main control module 500 includes a voltage stabilizing unit 520 and a MCU (main controller unit) 510. The MCU 510 is electrically connected to the BMS module 200 and the USB interface control module 600, respectively. The voltage stabilizing unit 520 is electrically connected to the BMS module 200 and the MCU 510, respectively, and the voltage stabilizing unit 520 is configured to stabilize the voltage supplied from the BMS module 200 to the MCU 510.

In the present embodiment, the voltage stabilizing unit 520 is implemented as a low dropout linear regulator. It is to be understood that, in the present embodiment, the MCU 510 is connected to the various modules to obtain the load connection status and the electrical parameters of each output interface. In addition, the voltage stabilizing unit 520 is further connected to the DC output interface 310 for providing a pull-up voltage to a connection detection circuit of the DC output interface 310, and the main control module 500 is further electrically connected to the connection detection circuit of the DC output interface 310 for obtaining the load connection status of the DC output interface 310. The connection detection circuit of the DC output interface may be an existing common detection circuit, and its specific circuit structure can be determined according to actual needs and should not be limited to any particular circuit structure.

Referring to FIG. 4, optionally, the BMS module includes a BMS control circuit 220 and a fuse 210. One end of the fuse 210 is connected to a positive electrode of the battery cell 100, and the other end of the fuse 210 is connected to a discharge input end of the BMS control circuit 220. A discharge output end of the BMS control circuit 220 is connected to the voltage transformation module 400, the USB interface control module 600, and part of the interfaces of the interface module 300, respectively, and a data transmission end of the BMS control circuit 220 is connected to the main control module 500.

It is to be understood that the fuse 210 provides non-recoverable cell protection for the battery cell 100, and in the event of a charge or discharge overcurrent in the battery cell 100 and the BMS control circuit 220 is unable to provide recoverable protection in time, the fuse 210 blows to protect the battery cell 100 and associated circuits.

Referring to FIG. 4, the voltage transformation module 400 includes a switch transistor 410 and a transformer 420. The switch transistor 410 includes an input end connected to the discharge output end of the BMS module 200, an output end connected to an input end of the transformer 420, and a control end connected to the main control module 500. An output end of the transformer 420 is connected to the DC output interface 310. The main control module 500 is further connected to an enabling end of the transformer 420, such that when detecting that the DC output interface 310 is connected with an external load, the main control module 500 enables the transformer 420 to operate and makes the switch transistor 410 conduct, so that the BMS module 200 outputs the discharge voltage of the battery cell 100 to the transformer 420, and the transformer 420 converts the discharge voltage of the battery cell 100 to a target output voltage and outputs it to the DC output interface 310. In addition, the main control module 500 is further connected with the DC output interface 310 and monitors the electrical parameters of the DC output interface 310 in real time, so as to control the switch transistor 410 to turn on or turn off according to the electrical parameters of the DC output interface 310. In this embodiment, the switch transistor 410 may be implemented as a field effect transistor or a bipolar transistor, and the specific circuit of the voltage transformation module 400 may be determined according to actual needs.

Referring to FIG. 5, the present embodiment is further provided with a key 930, a firmware burning interface 920, and a display module 800. The display module 800 may be an OLED display. The MCU 510 is electrically connected to the key 930, the firmware burning interface 920, and the display module 800, respectively, and the voltage stabilizing unit 520 is electrically connected to the display module 800. The key 930 is used to output a key signal to the MCU 510, and the MCU 510 is configured to control the display module 800 to display the electrical parameters such as the power level of the battery cell 100 and the electrical parameters of the respective or part of the connection interfaces based on the key signal. The firmware burning interface 920 is configured to connect with an external computer for burning a program into the MCU 510. The voltage stabilizing unit 520 is configured to supply power to the display module 800.

For example, this embodiment adopts two DC output interfaces 310 with different output voltage sizes (8V and 12V), and a corresponding transformer 420 is arranged for each of the two DC output interfaces 310, which is conducive to the compatibility with more DC interface types of electrical devices.

### Second Embodiment

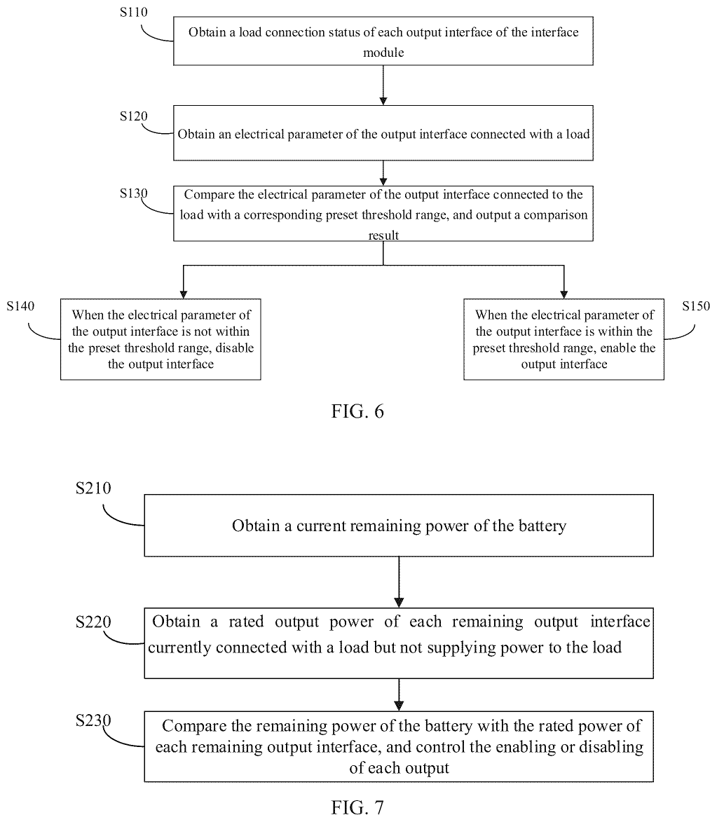

Referring to FIG. 6 through FIG. 11, this embodiment provides a discharge control method for use in the V-mount battery of the embodiment. The interface module 300 of the V-mount battery includes the BP electrode interface 320, the D-Tap interface 330, the DC output interface 310, the USB-C interface 350, and the USB-A interface 340.

As the V-mount battery includes multiple interfaces, simultaneous use of multiple interfaces will inevitably occur. If the interfaces are all connected to high power devices, a discharge overcurrent of the battery cell may occur. In case the battery cell discharge overcurrent occurs, the BMS terminates the battery cell discharge for safety. However, a sudden interruption of power supply will interrupt the photography process, and there is a risk of damaging the electrical device. In order to address this situation, the current solution is to increase the threshold of the discharge overcurrent for triggering the discharge termination, but this solution may cause rapid aging and shortened life of the battery cell, and during use rapid temperature rise may trigger BMS over-temperature protection to terminate the discharge.

Referring to FIG. 6, the discharge control method includes the following steps:
S110, obtaining a load connection status of each output interface of the interface module 300;
S120, obtaining an electrical parameter of the output interface connected with a load;
S130, comparing the electrical parameter of the output interface connected to the load with a corresponding preset threshold range, and outputting a comparison result;
For example, the main control module 500 obtains a preset current threshold range corresponding to the DC output interface 310, and compares the actual size of the output current of the DC output interface 310 with the preset current threshold range.
S140, when the electrical parameter of the output interface is not within the preset threshold range, disabling the output interface;
S150, when the electrical parameter of the output interface is within the preset threshold range, enabling the output interface.

In this embodiment, when the output interface is connected with an external load, the electrical parameter of the output interface is compared with the preset threshold range, and enabling or disabling of the output interface is controlled based on the comparison result, thereby protecting the discharge circuit and the external load of the V-mount battery. Each output interface is individually monitored, so that any interface that is abnormal can be disabled, without affecting the normal use of other interfaces, thus avoiding simultaneously disabling other output interfaces.

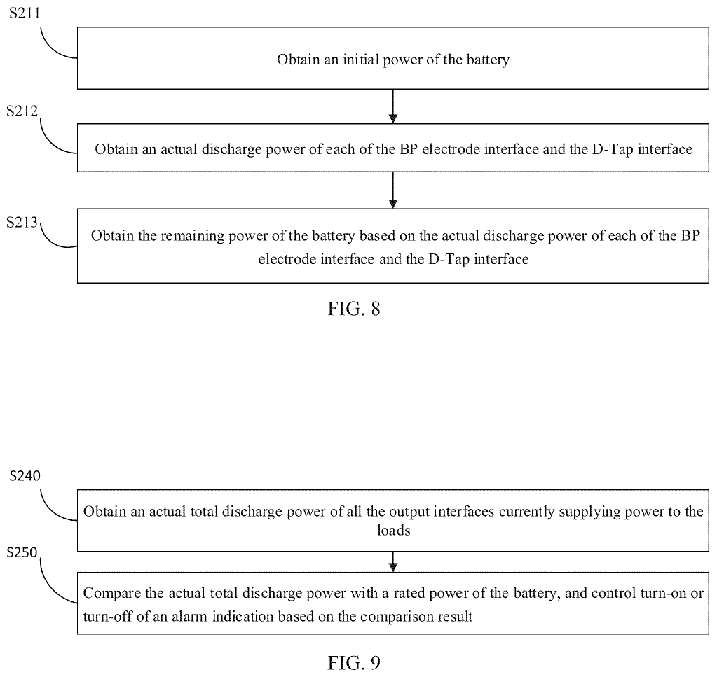

Referring to FIG. 7, optionally, the discharge control method further includes the following steps:
S210, obtaining a current remaining power of the battery;
Referring to FIG. 8, this step S210 includes:
S211, obtaining an initial power of the battery;
S212, obtaining an actual discharge power of each of the BP electrode interface 320 and the D-Tap interface 330; and
S213, obtaining the remaining power of the battery based on the actual discharge power of each of the BP electrode interface 320 and the D-Tap interface 330.

In this step S213, the remaining power of the battery is obtained by subtracting a sum of the actual discharge power of the BP electrode interface 320 and the D-Tap interface 330 from the initial power of the battery.
S220, obtaining a rated output power of each remaining output interface currently connected with a load but not supplying power to the load;
S230, comparing the remaining power of the battery with the rated power of each remaining output interface, and controlling the enabling or disabling of each output interface based on the comparison result.

In this step S230, when the remaining power of the battery is greater than or equal to the rated power of that remaining output interface connected with the load but not supplying power to the load, the corresponding remaining output interface is enabled; when the remaining power of the battery is less than the rated power of that remaining output interface, the corresponding remaining output interface is disabled.

It is to be understood that the remaining output interface with no external load connected thereto is in a disabled state. At the time an external load is connected to one remaining output interface, no electrical connection is established between the external load and the battery although the external load is positioned at the corresponding remaining output interface. The external load receives the power supply from the battery only when a comparison between the remaining power of the battery and the rated power of the corresponding remaining output interface shows that the enabling condition is satisfied and the corresponding remaining output interface is thereby enabled. For example, the V-mount battery may be provided with an indicator for each output interface to indicate that the load corresponding to the output interface is in position and electrically connected to the battery.

During use of the V-mount battery, the BP electrode interface 320 and the D-Tap interface 330 are used more frequently as main output interfaces, and are allocated with a larger proportion of the power at the same time. Therefore, the method first obtains the sum of the actual discharge power of the BP electrode interface 320 and the D-Tap interface 330 to obtain the remaining power of the battery. It is then determined whether the remaining power of the battery can satisfy the rated power of each remaining output interface. When the rated power is less than the remaining power of the battery, the corresponding output interface is enabled, and when the rated power reaches or exceeds the remaining power of the battery, the corresponding output interface is disabled. Further, if any of the remaining output interfaces is connected with an external load and starts supplying power to the external load, the remaining power of the battery is updated, and a comparison is again performed between the remaining power of the battery and the rated power of the remaining output interface that has a load in place but is not electrically connected with the load. By means of this discharge control strategy, the present embodiment first determines whether the remaining power of the battery can satisfy the rated power of the subsequently connected external load, and disables or enables the corresponding output interface based on the determination result, so as to further protect the battery cell, the circuit and the external load.

Referring to FIG. 9, optionally, the discharge control method further includes the steps of:
S240, obtaining an actual total discharge power of all the output interfaces currently supplying power to the loads;
In this step S240, the actual discharge power of each of the output interfaces currently supplying power to the load is first obtained, and then the actual total discharge power is obtained based on the actual discharge power of all the output interfaces;
S250, comparing the actual total discharge power with a rated power of the battery, and controlling turn-on or turn-off of an alarm indication based on the comparison result.

In this step S250, when the actual total discharge power is greater than or equal to the rated power of the battery, an alarm indication is generated; when the actual total discharge power is less than the rated power of the battery, the alarm indication is not generated. In some embodiments, the alarm indication lasts until any load is removed so that the actual total discharge power is less than the rated power of the battery, or until the BMS module switches off the discharge of the battery cell for circuit protection.

It is to be understood that, since the actual discharge power of each output interface with a load connected thereto may be less than or greater than the rated power, there is a possibility that the actual total discharge power of all the output interfaces is high. If the actual total discharge power reaches or exceeds the rated power of the battery, the battery is in an overloaded state, and then an alarm indication is timely generated and the load is manually removed to avoid instantaneous power interruption which may damage the electrical devices. The alarm indication may be one or more of a sound indication, light indication, etc. For example, the V-mount battery is provided with an alarm LED light and a buzzer connected to the main control module 500, and if the actual total discharged power of all the output interfaces with the loads connected thereto reaches or exceeds the rated power of the battery, the main control module 500 controls the alarm LED light to light up and triggers the buzzer.

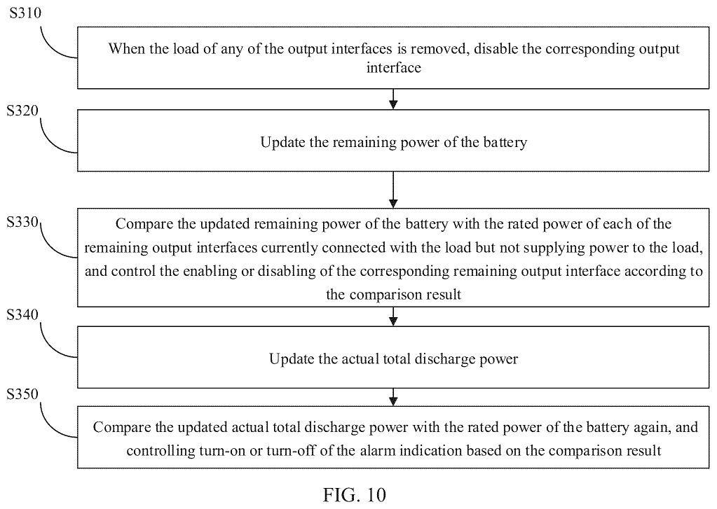

Referring to FIG. 10, the discharge control method further includes the steps of:
S310, when the load of any of the output interfaces is removed, disabling the corresponding output interface;
In this step S310, when the external load of any output interface is removed, the corresponding output interface is disabled to ensure circuit safety.
S320, updating the remaining power of the battery;
S330, comparing the updated remaining power of the battery with the rated power of each of the remaining output interfaces currently connected with the load but not supplying power to the load, and controlling the enabling or disabling of the corresponding remaining output interface according to the comparison result;
S340, updating the actual total discharge power;
S350, comparing the updated actual total discharge power with the rated power of the battery again, and controlling turn-on or turn-off of the alarm indication based on the comparison result.

It is to be understood that, the present embodiment realizes a dynamic power allocation scheme in which power is allocated according to the order of use of the remaining output interfaces, and upon removal of a load from one of the remaining output interfaces, the remaining power is calculated and the comparison is carried out again for reallocation of the power of the disabled output interface. This ensures the normal operation of the output interfaces currently being used and avoids overcurrent when supplying power to the external loads.

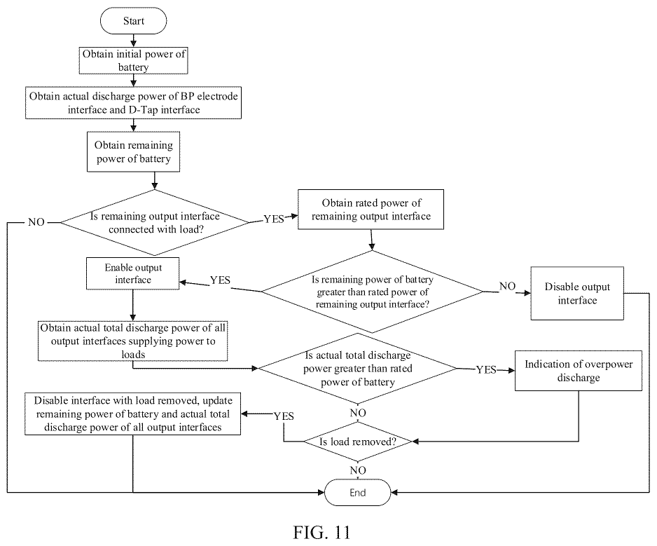

Referring to FIG. 11, this embodiment provides an exemplary workflow of the V-mount battery as follows: first, remaining power of the battery is obtained, and it is determined whether there is any remaining output interface connected to a load. Then, the rated power of the remaining output interface that is connected to the load is obtained, the rated power is compared with the remaining power of the battery, and the corresponding output interface is enabled according to the comparison result. Afterwards, the actual total discharge power of all the output interfaces currently supplying power to their loads is obtained and compared with the rated power of the battery cell, and an overpower discharge indication is given if the actual total discharge power is greater than the rated power of the battery cell. Upon removal of any of the loads, the output interface corresponding to the removed load is disabled, and the remaining power of the battery and the actual total discharge power of all output interfaces are recalculated and updated.

As can be seen, the V-mount battery of this embodiment can realize dynamic power allocation, prioritizing support for the discharge of the BP electrode interface and D-Tap interface, and the USB-A, USB-C, and DC output interfaces are managed in such a manner that whichever of the output interfaces is first connected to a load is first enabled to discharge power to the load, while the discharge of each remaining output interface being idle is limited when the rated power of the battery is insufficient. It ensures that the discharge current and temperature of the battery cell will not exceed the normal range, and any device that is being supplied with power can continue to work normally.

In summary, in embodiments of the V-mount battery and the discharge control method, the BMS module controls the input and output of the battery cell, so that when the DC output interface is connected to an external load, the BMS module outputs the discharge voltage of the battery cell to the voltage transformation module, and the voltage transformation module converts the discharge voltage to a target output voltage and then outputs it to the DC output interface, so as to supply power to the external load having a DC power supply interface, thereby avoiding the use of an additional V-mount plate, which is conducive to simplifying the assembly steps. As the DC output interface is disposed on the V-mount battery, the overall volume of the assembled devices such as the camera and the photography light can be reduced, and the integration of the DC output interface 310 with the battery cell 100 reduces external interference, thereby improving the stability of the power supply to the external load. The V-mount battery of the present disclosure is also equipped with a USB-A interface and a USB-C interface with fast charge function, which enriches the interface types of the V-mount battery and makes the V-mount battery compatible with more interface types and specifications of electrical devices.

In addition, in the discharge control method of this application, the actual discharge power of the BP electrode interface and the D-Tap interface is first detected, and the remaining assignable power of the battery is calculated. Upon connection of a load to a remaining interface, it is determined whether the assignable power of the battery can satisfy the rated discharge power of the remaining interface being currently connected to the load. If it can satisfy the rated discharge power of this remaining interface, this remaining interface is allowed to use; otherwise, this remaining interface is not allowed to use and an indication is given to the user. If the total power of the interfaces currently being used reaches the rated power of the battery, an indication of overpower discharge of the battery will be given to the user. This discharge control method can not only provide maximum discharge within the permissible range of battery discharge power to ensure the normal use of the devices, but it also allows the user to keep informed of the battery working status in time and allows for fast manual intervention.

Further, this application realizes three-level battery circuit safety protection. A first level protection is that each output interface is configured with electrical parameter detection, providing discharge overcurrent, charge overcurrent and overvoltage protection, which can disable an abnormal output interface without affecting the use of other output interfaces. A second level protection is BMS recoverable protection from the battery cell side, in which it is detected whether the battery cell's input and output current, voltage, temperature, quantity of charge, etc. reach upper and lower limits of their respective safety values, if there is any abnormality described above, the battery charge and discharge function will be temporarily disabled and all interfaces will not be allowed to use, and the battery charge and discharge function is recovered after the abnormal data is recovered to the safety value. A third level protection is non-recoverable protection, in which if the current and voltage are much higher than the normal range, the fuse will blow to avoid battery fire or explosion as well as damage to the electrical devices.

The above are only embodiments of the invention, and the patent scope of the invention should not be limited thereto. All equivalent transformations made on the basis of the embodiments and accompanying drawings of the present disclosure, or their direct or indirect applications in other related technical fields are included in the protection scope of the present invention.

What is claimed is:

1. A V-mount battery comprising:
a battery cell;
a BMS module electrically connected to the battery cell and configured to monitor electrical parameters of the battery cell and control input and output of the battery cell based on the electrical parameters of the battery cell;
an interface module electrically connected to the BMS module and configured to provide an output voltage to an external load based on a discharge voltage of the battery cell when connected to the external load, and to charge the battery cell when connected to an external power source, the interface module comprising a DC output interface; and
a voltage transformation module electrically connected to the BMS module and the DC output interface, respectively, the voltage transformation module being configured to convert the discharge voltage of the battery cell to a target output voltage and output the target output voltage to the DC output interface.

2. The V-mount battery according to claim 1, further comprising a main control module, the main control module being electrically connected to the interface module, the voltage transformation module, and the BMS module, respectively, the main control module being configured to obtain a load connection status and electrical parameters of each of output interfaces of the interface module, and the electrical parameters of the battery cell, and to control enabling and disabling of part of the output interfaces individually based on the load connection status and electrical parameters of each of the output interfaces of the interface module, and the electrical parameters of the battery cell.

3. The V-mount battery according to claim 2, wherein the interface module comprises a USB-A interface and a USB-C interface, and the V-mount battery comprises a USB interface control module and an Emark module;
wherein the USB interface control module is electrically connected to the BMS module, the Emark module, the USB-A interface, and the USB-C interface, respectively, and the USB interface control module is configured to, when at least one of the USB-C interface and the USB-A interface is connected to the external load, provide the output voltage to the corresponding external load according to the discharge voltage of the battery cell, and charge the battery cell when the USB-C interface is connected to the external power source;
wherein the Emark module is electrically connected to the USB-C interface; and
wherein the main control module is electrically connected to the USB interface control module, the main control module being configured to obtain the load connection status and electrical parameters of each of the USB-A interface and the USB-C interface through the USB interface control module, and to control enabling or disabling of the USB-A interface and USB-C interface individually according to the load connection status and electrical parameters of each of the USB-A interface and the USB-C interface.

4. The V-mount battery according to claim 3, wherein the main control module comprises a voltage stabilizing unit and a main controller unit;
wherein the main controller unit is electrically connected to the BMS module and the USB interface control module, respectively; and
wherein the voltage stabilizing unit is electrically connected to the BMS module and the main controller unit, respectively, and the voltage stabilizing unit is configured to stabilize a voltage supplied from the BMS module to the main controller unit.

5. The V-mount battery according to claim 3, wherein the BMS module comprises a BMS control circuit and a fuse;
wherein one end of the fuse is connected to a positive electrode of the battery cell, and the other end of the fuse is connected to a discharge input end of the BMS control circuit;
wherein a discharge output end of the BMS control circuit is connected to the voltage transformation module, the USB interface control module, and part of the interfaces of the interface module, respectively, and a data transmission end of the BMS control circuit is connected to the main control module.

6. The V-mount battery according to claim 5, wherein the voltage transformation module comprises a switch transistor and a transformer;
wherein an input end of the switch transistor is connected to the discharge output end of the BMS module, an output end of the switch transistor is connected to an input end of the transformer, a control end of the switch transistor is connected to the main control module, and an output end of the transformer is connected to the DC output interface.

7. A discharge control method for use in a V-mount battery according to claim 1, the interface module comprising a BP electrode interface, a D-Tap interface, the DC output interface, a USB-C interface, and a USB-A interface;
the discharge control method comprising:
obtaining a load connection status of each output interface of the interface module;
obtaining an electrical parameter of each output interface being currently connected with a load;
comparing the electrical parameter of the output interface being currently connected with the load with a corresponding preset threshold range, and outputting a comparison result;
when the electrical parameter of the output interface is not within the preset threshold range, disabling the corresponding output interface; and
when the electrical parameter of the output interface is within the preset threshold range, enabling the corresponding output interface.

8. The discharge control method according to claim 7, wherein the discharge control method further comprises:
obtaining a current remaining power of the battery;
obtaining a rated power of each remaining output interface currently connected to the load but not supplying power to the load;
comparing the remaining power of the battery with the rated power of each remaining output interface, and controlling the enabling and disabling of the corresponding remaining output interface according to the comparison result.

9. The discharge control method according to claim 8, further comprising:
obtaining an actual total discharge power of all output interfaces currently supplying power to their loads; and
comparing the actual total discharge power with the rated power of the battery, and controlling turn-on or turn-off of an alarm indication based on a comparison result.

10. The discharge control method according to claim 9, further comprising:
when the load of any output interface is removed, disabling the output interface corresponding to the load removed;
updating the remaining power of the battery;
comparing the updated remaining power of the battery with the rated power of each remaining output interface currently connected to the load but not supplying power to the load, and controlling the enabling and disabling of the corresponding remaining output interface according to the comparison result;
updating the actual total discharge power;
comparing the updated actual total discharge power with the rated power of the battery again, and controlling turn-on and turn-off of the alarm indication based on the comparison result.
